(19) United States
(12) Patent Application Publication
(10) Pub. No.: US 2012/0204790 A1
(43) Pub. Date: Aug. 16, 2012

(54) APPARATUS FOR DISPENSING OBJECTS ON A SUBSTRATE

(76) Inventors: Gil Ozmo, Bat Yam (IL); Klemi Ozmo, Bat Yam (IL); Shlomo Osmo, Bat Yam (IL)

(21) Appl. No.: 13/503,578

(22) PCT Filed: Oct. 21, 2010
(86) PCT No.: PCT/IL2010/000866

§ 371 Date: Apr. 23, 2012

(30) Foreign Application Priority Data
Oct. 27, 2009 (IL) 201771
Oct. 6, 2010 (IL) 208509

(51) Int. Cl. B05C 5/00

(52) U.S. Cl. 118/300

(57) ABSTRACT

An apparatus (1; 200; 300) for deploying objects such as candies (23) from an objects dispenser on to an underlying substrate such as cake (3) according to a selected pattern, the apparatus comprising a rigid frame (10; 202; 302) and at-least one beam (13; 203; 303) extending across the frame, with an objects dispenser device (22; 210; 310) mounted to the beam. Selectively operable first means (205; 305) are provided for bi-directionally propelling the objects dispensing device over said at-least one beam. Selectively operable second means (202; 343) are provided for propelling the said at-least one beam over the said frame, whereby operating one, the other or both of said first and second means the dispensing device is movable to overlie any pre-selected point over said substrate.

### FIELD OF THE INVENTION

The present invention generally relates to dispensers for creating patterns on a substrate, and specifically to a dispenser for deploying solid objects on a substrate according to a selected pattern.

### BACKGROUND OF THE INVENTION

Dispensers for creating (forming) patterns on a substrate are generally well known in the art. Examples of such dispensers may be typically found in jet ink printers and other types of printers, wherein fluid ink is sprayed onto a surface of a paper or other type of printable substrate material and a pattern is formed. Other examples may include equipment which spray a fine powder or a combination of powders, onto a substrate such as in sand or an adhesive material, forming the pattern.

As the case may be, generally, the apparatus used for forming patterns on a substrate are based on spraying fluids or relatively finely ground solids such as powders, onto the substrate. As a result, apparatus for creating patterns with solids (in sizes larger than that of ground solids which may be sprayed) on a substrate, are little known, if at all.

It is therefore the prime object of the invention to overcome this drawback of conventional pattern-forming equipment.

It is a further object of the invention to provide a novel apparatus which allows for dispensing solid objects on a substrate according to a selected pattern.

It is still a further object of the invention to provide for a remotely controlled apparatus which automatically dispenses solid objects on a substrate according to a pre-selected pattern.

### SUMMARY OF THE INVENTION

There is provided, in accordance with an embodiment of the present invention, an apparatus for deploying objects from an objects dispenser on to an underlying substrate according to a selected pattern, the apparatus comprising a rigid frame; at-least one beam extending across the frame; an objects dispenser device mounted to the beam selectively operable first means for bi-directionally propelling the objects dispensing device over said at-least one beam; selectively operable second means for propelling the said at-least one beam over the said frame, whereby operating one, the other or both of said first and second means the dispensing device is movable to overlie any pre-selected point over said substrate.

### BRIEF DESCRIPTION OF THE DRAWINGS

These and additional constructional features and advantages of the invention will become more clearly understood in the light of the following description of several preferred embodiments thereof given by way of example only, with reference to the attached drawings, wherein—

FIG. 1 schematically illustrates an isometric, exploded view of an exemplary apparatus for manually deploying objects on a substrate according to a selected pattern, in accordance with an embodiment of the present invention;

FIG. 2 is a partial, enlarged isometric view of an objects dispenser on a carriage in the exemplary apparatus of FIG. 1;

FIG. 3 is a side view of a carriage member and a gear-type mechanism used to provide movable support to the carriage member of the apparatus shown in FIG. 1;

FIG. 4 is a cross-sectional view IV-IV of FIG. 3;

FIG. 5 us a sectional view of the objects dispenser mounted on a section of the carriage shown in FIG. 2;

FIG. 6 is a cross-sectional view VI-VI of the of the objects dispenser of FIG. 5;

FIGS. 7 and 8 are two assembly positions of the mold for supporting the substrate shown at the bottom of FIG. 1;

FIG. 9 is an isometric view of an exemplary radio-controlled apparatus for remotely deploying objects on a substrate according to a selected pattern, in accordance some embodiments of the present invention;

FIG. 10 is a sectional view of a carriage member and a gear-type mechanism used to provide movable support to the carriage member, in the exemplary radio-controlled apparatus shown in FIG. 9;

FIG. 11 is a block-diagram of the apparatus of FIGS. 9 and 10;

FIG. 12 schematically illustrates a system including a variety of devices for remotely controlling the apparatus of FIG. 9;

FIG. 13 illustrates a flow diagram of an exemplary method of operating the apparatus of FIG. 9, in accordance with some embodiments of the present invention.

FIG. 14 is a schematic isometric view of a second preferred embodiment of the invention;

FIG. 15 is a top view of FIG. 14;

FIG. 16 is a section XVI-XVI of FIG. 15;

FIG. 17 is a section XVII-XVII of FIG. 15;

FIG. 18 is a is a section XVIII-XVIII of FIG. 17;

FIG. 19 is a section XIX-XIX of FIG. 17;

FIG. 20 is a section XX-XX of FIG. 18;

FIG. 21 is similar to FIG. 17 but is the operative, object dispensing position;

FIG. 22 is a section XXII-XXII of FIG. 21;

FIG. 23 is a section XXIII-XXIII of FIG. 21;

FIG. 24 is an isometric view of a slider member shown in FIGS. 20 and 22;

FIG. 25 is a schematic isometric view of still an additional preferred embodiment of the present invention;

FIG. 26 is a top view of FIG. 25;

FIG. 27 is a section XXVII-XXVII of FIG. 26;

FIG. 28 is a section XXVIII-XXVIII of FIG. 26; and

FIG. 29 is a section XXIX-XXIX of FIG. 27.

### DETAILED DESCRIPTION OF THE EMBODIMENTS

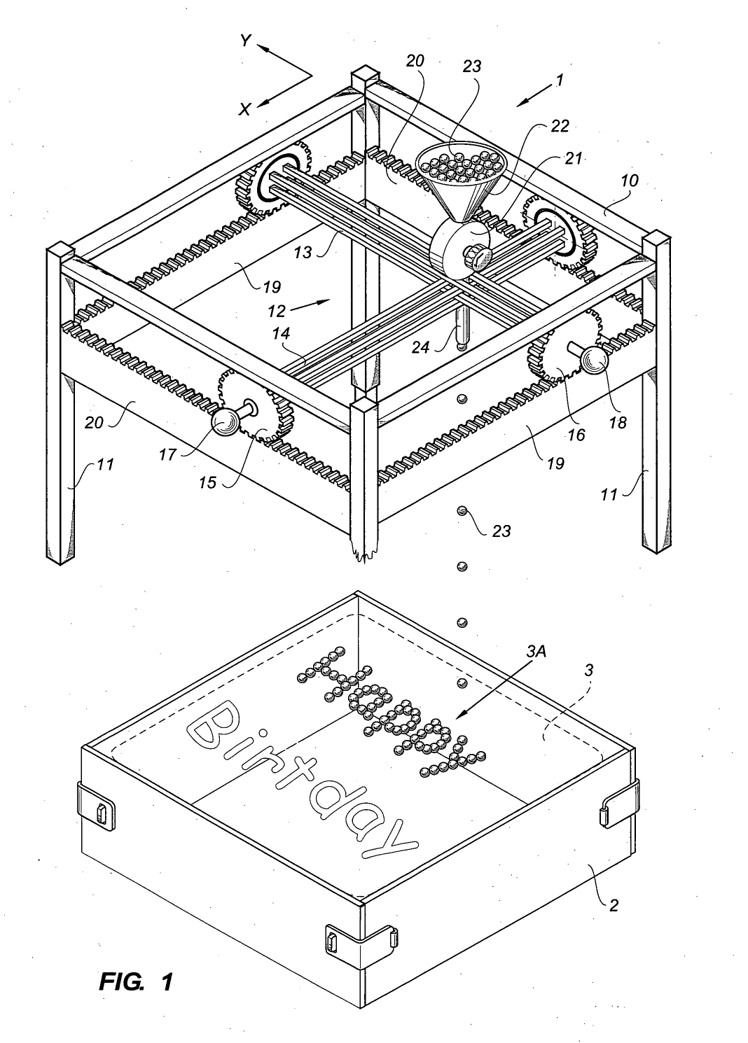

Reference is made to FIG. 1 which schematically illustrates an isometric diagram of an exemplary apparatus 1 for manually deploying objects 23 on a substrate 3 according to a selected pattern, in accordance with an embodiment of the present invention. Apparatus 1 includes an objects dispenser 21 which may be moved along an x-axis and/or a y-axis in an x-y plane to reach substantially all points (coordinates) within a virtual horizontal x-y grid (not shown) defined by the confines of a rigid frame 10, for creating a pattern, for example as shown at pattern 3A, on substrate 3. Optionally, the x-y grid is not horizontal, and may include an inclination. Pattern 3A is formed by successively placing dispenser 21 over any selected points on the x-y grid and laying objects 23 onto substrate 3 one by one.

Dispenser 21 deployment of object 23 may include the use of gravity to direct the object towards a pre-set location on substrate 3. Optionally, dispenser 21 may include the use of other means to direct object 23 to the pre-set location on the substrate including firing the object at the substrate and which may include, for example, using electrical means and/or hydraulic means. Deployment of object 23 may be made in a direction perpendicular to the horizontal x-y grid. Optionally, deployment may be made in a direction angularly displaced relative to the horizontal x-y grid, for example, in an angle ø ranging between 0-90 degrees, for example 45 degrees.

Rigid frame 10 includes two opposing first and second frame members 19 parallelly projected along the x-axis in the x-y plane, and two opposing first and second frame members 20 parallelly projected along the y-axis in the x-y plane. Four frame members 19 and 20 substantially form a rectangular frame supported by four legs 11 and substantially define the confines of the x-y grid within which dispenser 21 may be operable. Frame members 19 and 20 are supported by legs 11 at a height wherein substantially all points on the x-y grid lie on a horizontal plane above substrate 3. Optionally, frame members 19 and 20 may be supported by legs 11 at a height wherein the x-y grid is inclined at the angle ø, for example by supporting one frame member 19 higher than opposing frame member 19 relative to a horizontal surface (not shown) supporting substrate 3. Optionally, one frame member 20 may be positioned higher than other frame member 20.

Displacement of dispenser 21 to substantially all points in the x-y grid is by means of a carriage 12 supported by frame members 19 and 20. Carriage 12 includes a first elongated carriage member 13 which extends between first and second frame members 19, and further includes a second elongated carriage member 14 which extends between first and second frame members 20.

Dispenser 21 is mounted on carriage 12 at a movable intersection of carriage members 13 and 14, such that translation of carriage member 13 along the x-axis, and translation of carriage member 14 along the y-axis, allows the dispenser to substantially reach all points on the x-y grid. Carriage member 13 includes at both ends movable means 15 which are supported by frame members 20 and allow for the translation along the y-axis. Carriage member 14 includes at both ends movable means 16 which are supported by frame members 20 and allow for the translation along the x-axis. In some embodiments, movable means 15 and/or 16 may include a gear-type wheel as shown. Optionally, other means may be used such as, for example, a rubber wheel, a metal wheel, a plastic wheel, and the like. Additionally, movable means 15 and/or 16 may be of a non-roller type and may be able to slide along frame members 20 and 19, respectively.

Carriage members 13 and 14 may be physically propelled (moved) along the x-axis and/or y-axis by a user, by pushing or pulling on a handle 17 connected to gear wheel 15, and/or on a handle 18 connected to gear wheel 18, respectively, until dispenser 21 is positioned at a point corresponding to the one or more points wherein objects 23 are deployed to form selected pattern 3A. Once positioned at a corresponding point for deployment, dispenser 21 may be manually actuated by the user to deploy object 23 onto substrate 3, for example, by turning a knob 25.

In an exemplary application of apparatus 1, the apparatus is shown in FIG. 1 deploying objects 23 represented by round-shaped candy, onto substrate 3 represented by a cake inside a cake mold 2, and forming a pattern 3A represented by “Happy Birthday”. The food decoration example shown is intended to show one of many applications of apparatus 1, and is therefore not intended to be limiting in any way, form or manner. It should be evident to an ordinary person skilled in the art that there may be numerous applications for such type of apparatus. For example, applications may be found in architecture involving creation of patterns in floor tiles, pavements, sidewalks, gardens, and the like. Other applications may be in the arts, for example for use in mosaics. Still other may include scientific applications involving placement of materials in the form of solid objects in substrates at predetermined locations.

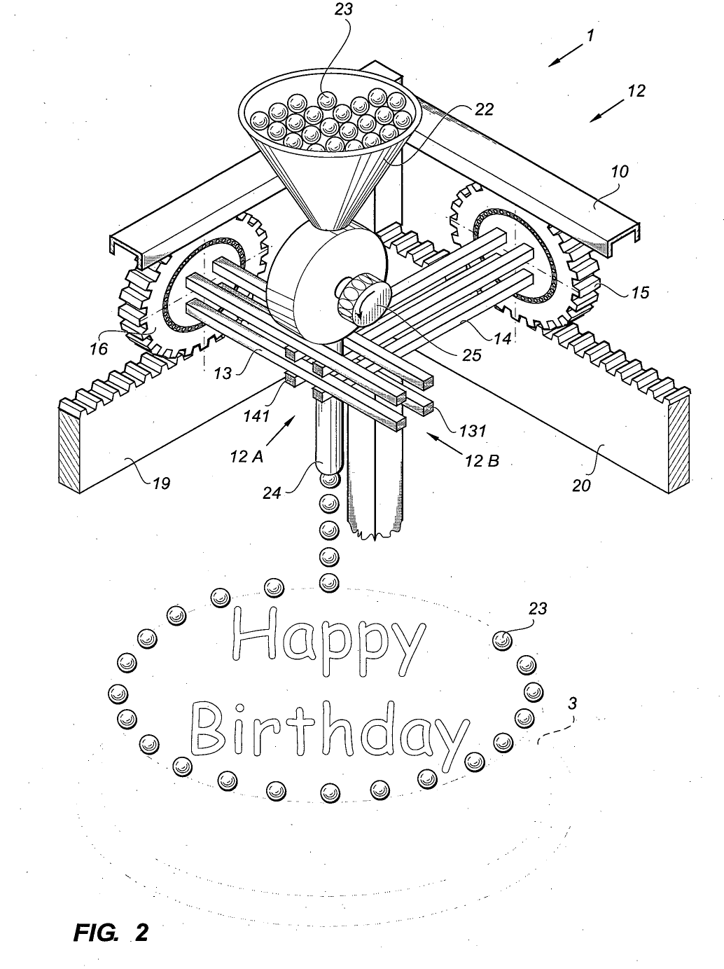

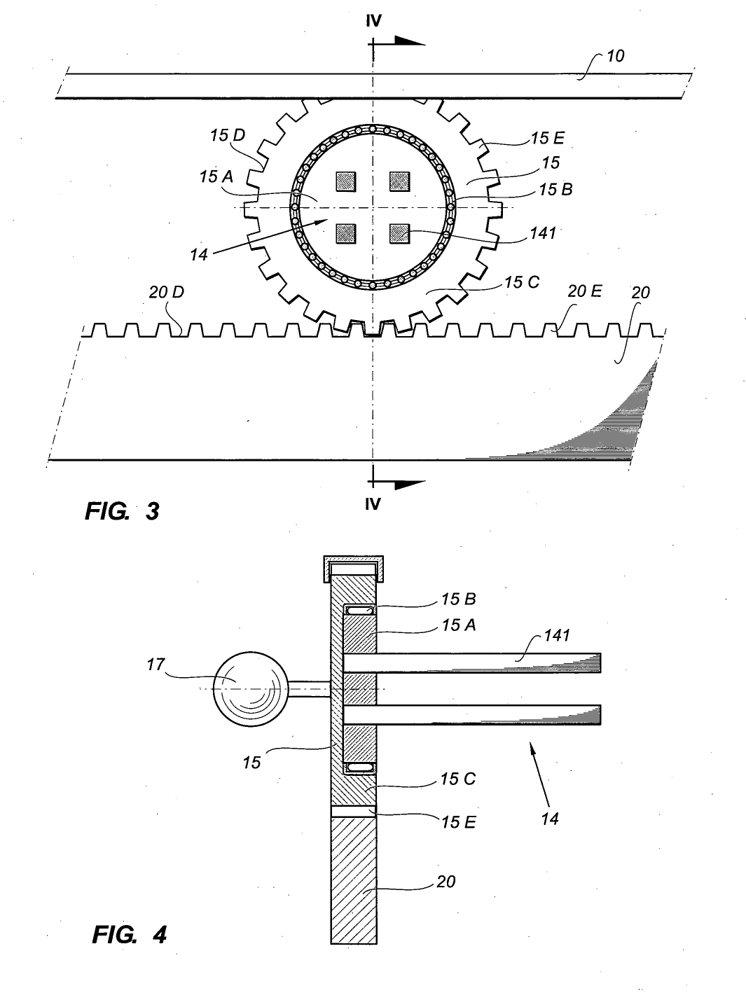

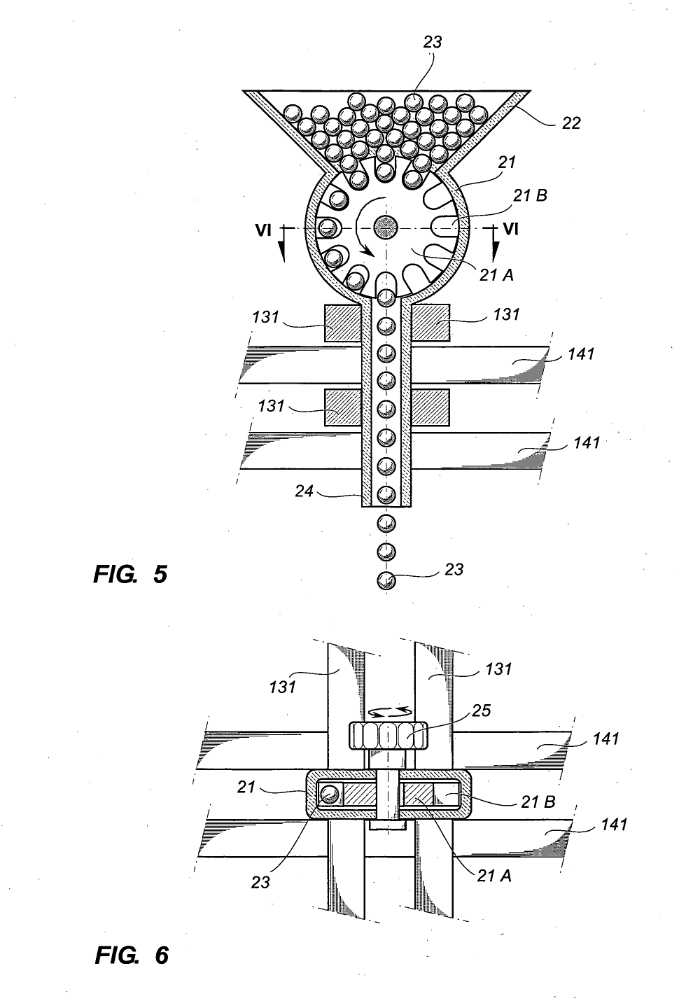

Reference is also now made to FIG. 2 which schematically illustrates an enlarged isometric view of objects dispenser 21 on carriage 12; to FIG. 3 which schematically illustrates a side view of carriage member 13 and gear-type wheel 15; to FIG. 4 which schematically illustrates a cross-sectional view IV-IV of carriage member 13 and gear-type wheel 15; to FIG. 5 which schematically illustrates a sectional view of objects dispenser 21 mounted on a section of carriage 12; and to FIG. 6 which schematically illustrates a cross-sectional view VI-VI of the of objects dispenser 21; all in accordance with an embodiment of the present invention.

Dispenser 21 includes a feeder receptacle 22, hereinafter referred to as “feeder”, for placing a plurality of objects 23 which are to be deployed by the dispenser, and which feeds the objects to the dispenser as they are deployed. Feeding of object 23 into dispenser 21 may be based on gravitation. Optionally, other means may be used which may include, for example use of air pressure (e.g. a suction force from the dispenser pulls the object from the feeder). Placement of objects 23 in feeder 22 may be manually performed by the user. Optionally, placement may be automatic, for example, by a sleeve or other supply means which connects to feeder 22 and automatically maintains a supply of objects 23 based on, for example, a per-demand basis as the level of the objects in the feeder decreases; or on a per-count basis replacing the objects as their number is depleted by counting the number deployed; or based on a predetermined criteria; or any other method for determining a requirement for a resupply of the objects; or any combination thereof.

Dispenser 21 includes a carrousel 21A including a plurality of slots 21B each for accommodating an object 23 which is fed into the dispenser from feeder 21. As dispenser 21 is positioned at the respective points in the x-y grid associated with the selected pattern in substrate 3, knob 25 is turned so that carrousel 21A rotates and an object 23 in one of the slots 21B is transferred to an opening leading to an ejector 24.

Deployment of object 23 from dispenser 21 and onto substrate 3 is made through ejector 24, which may include an elongated tube for passing one object 23 at a time, or optionally, a plurality of objects at a time. Ejector 24 is positioned in dispenser 21 so as to allow deployment of object 23 in a direction, as previously described, perpendicular to the horizontal x-y grid. Optionally, deployment may be made in a direction angularly displaced relative to the horizontal x-y grid, for example, in an angle ø ranging between 0-90 degrees, for example 45 degrees.

As previously described, dispenser 21 is mounted on carriage 12 at a movable intersection 12A of carriage members 13 and 14, and in such a manner that the carriage members may be moved while supporting the dispenser which may be slidingly displaced with the intersection. In some embodiments, support of dispenser 21 may be by means of ejector 24, which may include a contour along a whole of, or a portion of, its elongated shape which may be accommodated at intersection 12A. As may be seen in FIG. 2, carriage members 13 and 14 each include four beams 131 and 141, respectively, the beams of each carriage member continuously crossing the beams of the other carriage member as the carriage members are displaced along the x-axis and the y-axis, respectively, thereby continuously providing a slot 12B along which dispenser 21 may slidingly move. Optionally, carriage member 13 and/or 14 may include two beams which continuously cross the beams of the other carriage member forming slot 12B. Optionally, carriage member 13 and/or 14 may include a single beam with a slot extending along a major portion of the beam, such that when one carriage member is crossed with the other, movable intersection 12A is formed allowing for dispenser 21 to slidingly move with the movable intersection.

Beams 131 and 141 are attached at both ends to gear-type wheels 16 and 15 respectively, as previously described with relation to carriage members 13 and 14 in FIG. 1. To maintain axial movement (along x-axis and y-axis) of carriage members 13 and 14 with minimum torsion on the beams due to turning of gear-type wheels 16 and 15, respectively, the gear-type wheels include a floating inner section to which the beams are attached, the floating inner section divided from a rotating outer section by a circumferential ball-bearing slot. This may be viewed in FIGS. 3 and 4, where gear-type wheel 15 includes an inner section 15A, an outer section 15C, and a circumferential ball bearing slot 15B dividing between the two sections and allowing for rotation of the outer section while the inner section is maintained non-rotating, whereby no torsion forces are applied to beams 141. As seen in the figures, movement of the gear-type wheels along frame members 19 and/or 20, include an interlocking of teeth and slots on the wheel (teeth 15E and slots 15D on wheel 15) with teeth and slots on the frame members (teeth 20E and slots 20D on frame member 20).

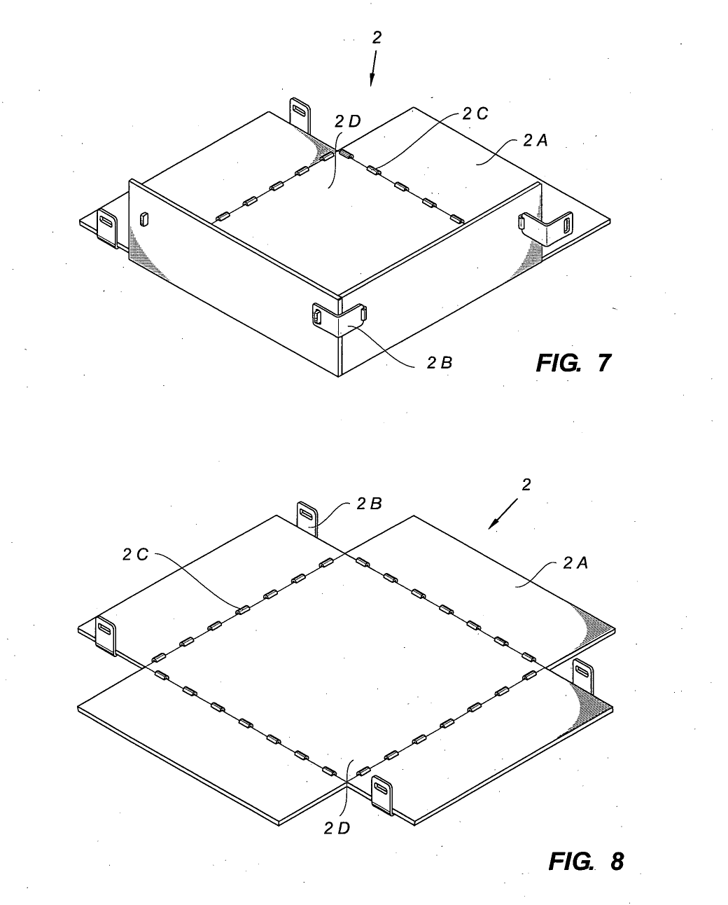

Reference is also now made to FIGS. 7 and 8 which schematically illustrate assembly diagrams for mold 2 for supporting substrate 3, in accordance with some embodiments of the present invention. Mold 2 includes a bottom 2D and four sides 2A attached to bottom 2D with hinges 2C, the sides being attached to one another by clips 2B. Mold 2 may be used in those applications where apparatus 1 is used to form patterns on substrates which may be handled by a user, as may be, for example, in food decoration (e.g. decorating a cake with a pattern), in tile fabrication, and the like.

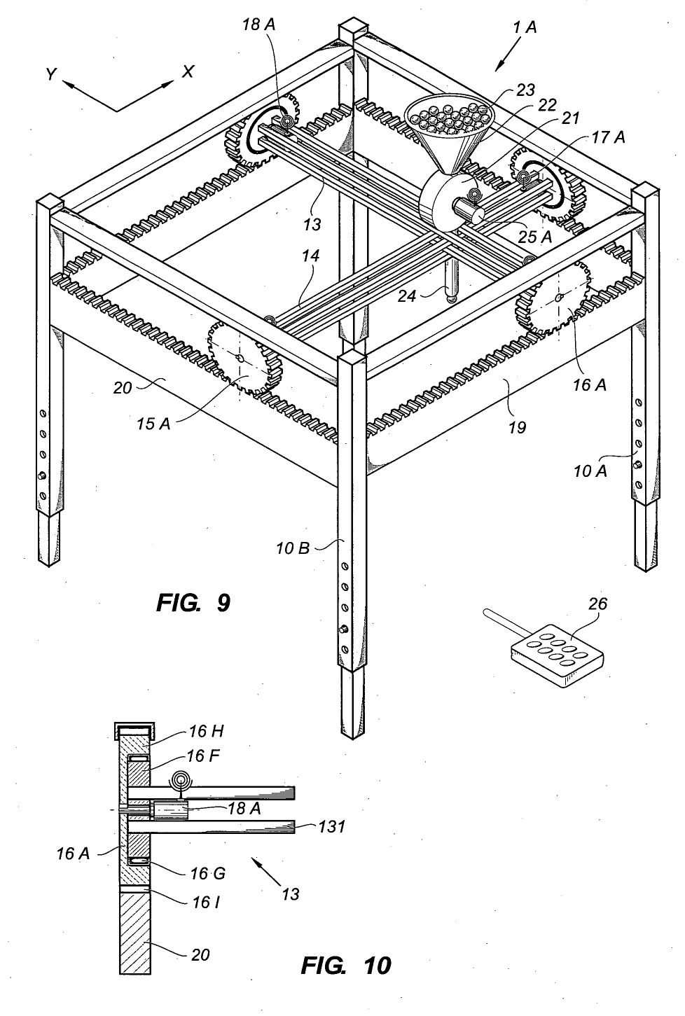

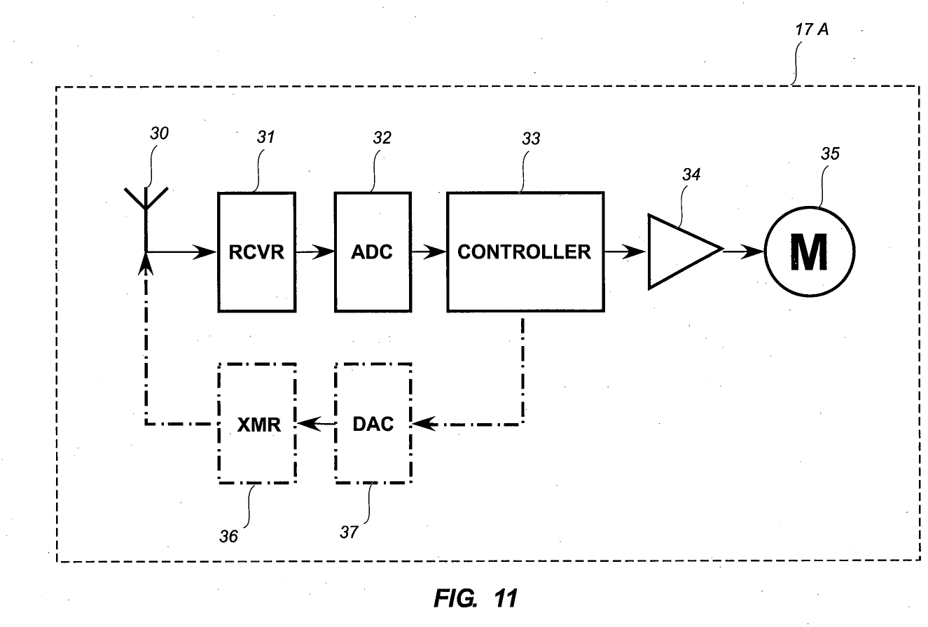

FIG. 9 schematically illustrates an isometric diagram of an exemplary radio-controlled apparatus 1A for remotely deploying objects 23 on substrate 3 according to a selected pattern, in accordance with some embodiments of the present invention. Apparatus 1A is similar to apparatus 1 shown in FIG. 1 with a difference that apparatus 1A may be remotely controlled by the user operating a radio control transmitter 26. Radio control transmitter 26 sends radio frequency (RF) signals to servo drive 17A and 18A on carriage members 13 and 14, respectively, the drives including motors mounted on gear-type wheels 15A and 16A for axially moving the wheels on frame members 20 and 19. Radio control transmitter 26 optionally sends RF signals to servo drive 25A in dispenser 21′, which is similar to dispenser to dispenser 21 in FIG. 1 with the exception of the remote control feature described herein, for actuating a motor in the dispenser which turns the carrousel for ejecting object 23 through ejector 24, and/or for feeding the dispenser from feeder 23. Servo drives 17A, 18A, and 25A, each include a receiver, a motor, and appropriate control electronics, and are shown in greater detail in FIG. 11 described further on below.

Apparatus 1A includes a frame 10A which is similar to frame 10 in FIG. 1 with the exception that frame 10A is supported by extendable legs 10B. Optionally, frame 10 in FIG. 1 may also be supported by extendable legs 10B.

FIG. 10 schematically illustrates a sectional view of carriage member 13, including beams 131, and gear-type wheel 16A used to provide movable support to the carriage member, in accordance with some embodiments of the present invention. Gear-type wheel 16A and gear-type wheel 15A are similar to that shown in FIG. 1 at 16 and 15, with the exception that gear wheels 16A and 15A may be driven by the motors in servo drives 18A and 17A, respectively, responsive to the drivers receiving an RF signal from transmitter 26.

Similarly to apparatus 1, beams 131 and 141 are attached at both ends to gear-type wheels 16A and 15A respectively. To maintain axial movement (along x-axis and y-axis) of carriage members 13 and 14 without torsion on the beams due to turning of gear-type wheels 16A and 15A, respectively, the gear-type wheels include a floating inner section to which the beams are attached, the floating inner section divided from a rotating outer section by a circumferential ball-bearing slot. This may be viewed in FIG. 10, where gear-type wheel 16A includes an inner section 16F, an outer section 16H and a circumferential ball bearing slot 16G dividing between the two sections and allowing for rotation of the outer section while the inner section and respective beams 131 remain non-rotating, as already explained above. As seen in the figures, movement of the gear-type wheels along frame members 19 and/or 20, include each a rack of teeth. The motors in the drives, for example drive 18A, are affixed to their respective beams 131 as well as coupled (at 18B) to the outer section of the gear wheels, for example outer section 16H, causing the wheel 16A to rotate responsive to motor activation (rotation). The motors may be bidirectional motors for rotating in a clockwise, and counterclockwise, direction. Optionally, the driver include two motors for each gear wheel, one motor to provide gear wheel movement axially in one direction by rotating in a clockwise direction, and the second motor to provide gear wheel movement axially in an opposite direction by rotating in a counterclockwise direction.

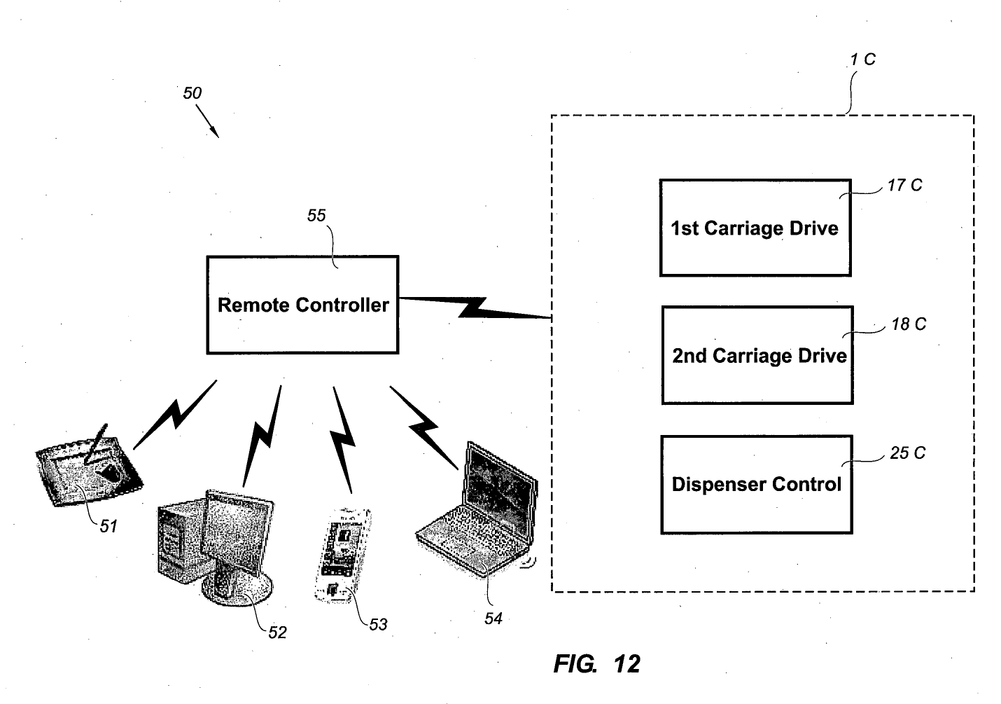

FIG. 11 schematically illustrates a functional block diagram of exemplary servo drive 17A used to drive gear-type wheel 14A in radio-controlled apparatus 1A responsive to control RF signals received from transmitter 26, in accordance with some embodiments of the present invention. Servo drive 17A is shown including an antenna 30, a receiver 31, an analog-digital converter (ADC) 32, a controller 33, an amplifier 34, and a motor 35. Optionally, servo drive 17A may include a transmission portion which may include a digital-analog converter (DAC) 37 and a transmitter 36 and which will be described in relation to FIG. 12 further on below. For those applications where drive 17A includes transmission capabilities, antenna 30 may be a bidirectional antenna. Servo drives 18A and 25A may include a similar configuration to that of drive 17A, appropriately modified according to their application. The exemplary functional block diagram shown for servo drive 17A is not intended to be limiting, and it should be evident to an ordinary person skilled in the art that the servo drive may be implemented in many different forms, ways and/or manners.

In a typical application antenna 30 receives a modulated RF signal, which may be for example a pulse width modulated (PWM) signal, from transmitter 26 at a predetermined carrier frequency, for example, 2.4 GHz. The signal is processed by receiver 31 which filters and demodulates the RF signal to an original baseband signal. The baseband signal, which is an analog signal, is then processed by ADC 32 where it is converted into a digital signal for processing by controller 33 (substantially similar to an original digital signal produced by transmitter 26). Optionally, according to the type of modulation, ADC 32 may not be required, for example when the RF signal is modulated using PCM (pulse code modulation). Responsive to the received signal controller 33 generates a motor drive signal which is amplified by amplifier 34 for driving motor 35. Optionally, amplifier 34 may be a voltage to current converter for generating a required current for driving motor 35. Feedback control for substantially accurate positioning of gear wheels 15A and 16A by servo drives 17A and 18A, and for accurate positioning of the carrousel in dispenser 21′ by servo drive 25A, may be done by controller 33.

FIG. 12 schematically illustrates an exemplary system 50 including an apparatus 1C which is remotely controlled and automatically dispenses solid objects on a substrate according to a pre-selected pattern, in accordance with some embodiments of the present invention. Apparatus 1C may be similar to that shown in FIG. 9 at 1A, and includes a first carriage drive 17C, a second carriage drive 18C, and a dispenser control 25C, which may be similar to that shown in FIG. 9 at 17A, 18A and 25A.

Apparatus 1C may be remotely controlled by a remote controller 55 which may be configured to interface with any type of computing device, which may include for example, a tablet computer 51, a personal computer (or a work station) 52, a personal digital assistant (PDA) 53, a laptop computer 54, a mobile phone (not shown), among others. The computing devices may be used for inputting a pattern, or optionally a plurality of patterns, to be created by the apparatus. Optionally, the computing devices may be used for inputting other apparatus control information as may be required from time to time, and which may include, for example, apparatus self-test operations, communication checks, description of operational sequences, among many other functions which may generally by controlled through computing devices. In some embodiments, all functions may be downloaded partially, or wholly, from the computing device to remote controller 55 and are stored in the controller. Optionally, the interfacing between the computing device and remote controller 55 may be real-time as the controller controls apparatus 1C. In some embodiments, some or all of the computing devices may interface directly with carriage drive 17C, 18C, and/or 25C.

Interfacing may be through any communications mode known in the art and may include wireless and/or wired communications. Wireless communications may comprise RF (radio frequency waves) and may include, for example, a wireless local area network (WLAN) such as Wi-Fi, WPAN (Wireless Personnel Area Network), WiMAX, MBWA (Mobile Broadband Wireless Access), and/or WRAN (Wireless Regional Area Network), or any combination thereof. Wired communications may include, for example, direct cabling, telephone network, electric network, CATV, or any combination thereof.

In some embodiments, carriage drive 17C, 18C and/or 25C may communicate with remote controller 55 through a transmitter portion of the drives. The transmitter portion, as previously mentioned, include DAC 37 to convert digital signals from controller 33 to analog signals which may be modulated by a carrier signal in transmitter 36 prior to transmission to remote controller 55. Optionally, depending on the type of modulation, DAC 37 may not be required. Information which may be transmitted from the drives to remote controller 55 may be optionally transmitted by the controller to the computing devices for display on the devices and/or further processing by the devices. Optionally, the information is directly transmitted from the drives to the computing devices. Information which may be transmitted may include positioning information of the dispenser, quantity of objects deployed, quantity remaining, results of self tests, pattern being formed including status of the pattern, among other information.

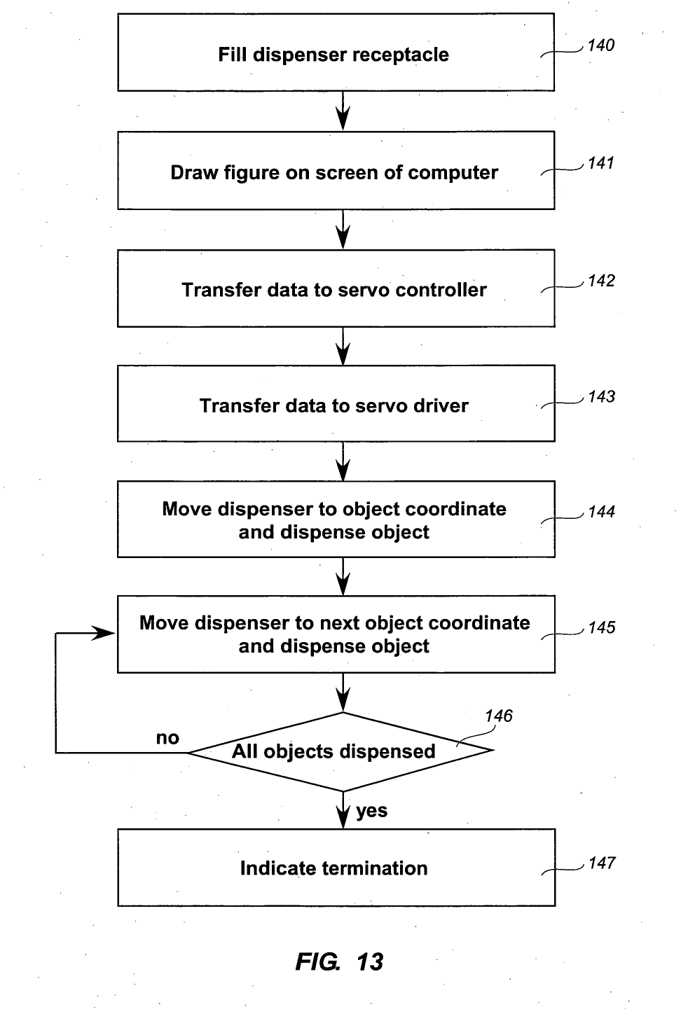

Reference is made to FIG. 13 which illustrates a flow diagram of an exemplary method of operating apparatus 1C in FIG. 12, optionally apparatus 1A in FIG. 9, in accordance with some embodiments of the present invention. Reference is made both to the parts in FIG. 9 (apparatus 1A) and to FIG. 13 (system 50). The exemplary method described is not intended to be limiting, and it should be evident to an ordinary person skilled in the art that the method may be implemented in many different forms, ways and/or manners.

At 140, feeder 22 is filled with an amount of objects 23 required to form a pattern on the substrate.

At 141, the pattern to be formed on the substrate is input to the computing device by a user.

At 142, all control information required for apparatus 1C to prepare the pattern on the substrate, including the pattern, is transferred from the computing device to remote controller 55. The information may be downloaded to the controller in a single batch, in multiple batches, or real-time as apparatus 1C forms the pattern, or any combination thereof.

At 143, remote controller 55 sends required information for forming the pattern to carriage drives 17C, 18C, and dispenser control 25C. The information may be sent in a single batch and downloaded to each controller 33, or optionally in multiple batches, or may be sent real-time as the pattern is being formed, or any combination thereof.

At 144, dispenser 21′ is moved to a first object coordinate on the x-y grid where first object 23 is deployed.

At 145, dispenser 21′ is moved to next object coordinate on x-y grid where next object 23 is deployed.

At 146, remote controller 55 verifies if all objects 23 are deployed and the pattern is complete (have all object coordinates on x-y grid been covered). If yes, continue. If no, go to 145. Optionally, the computing device performs the verification based on input information from remote controller 55. Optionally, controller 33 on the servo drives verify the status by comparing with previously downloaded data.

At 147, remote controller 55 receives an indication from dispenser control 25A that all objects 23 have been deployed. Remote controller 55 communicates this information to the computing device.

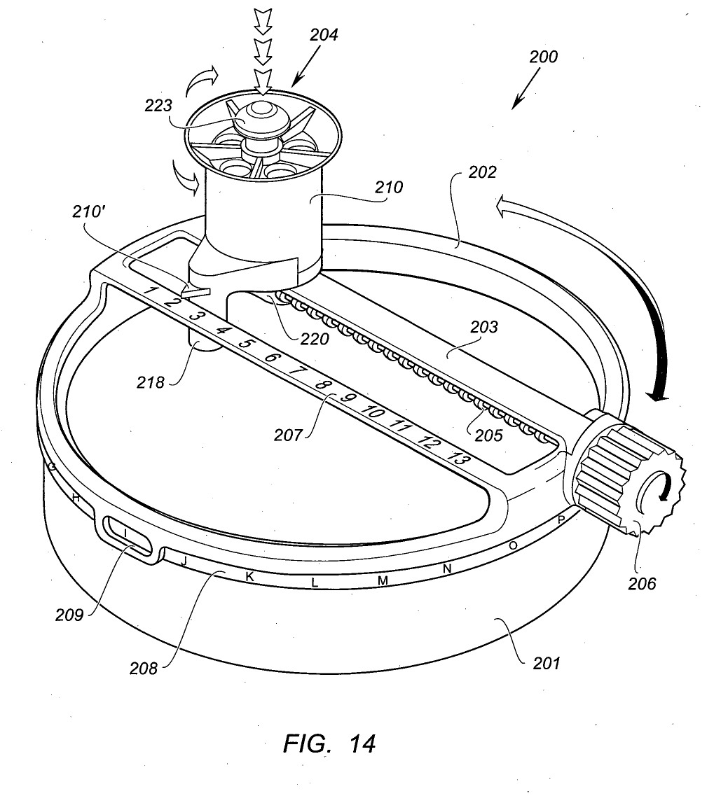

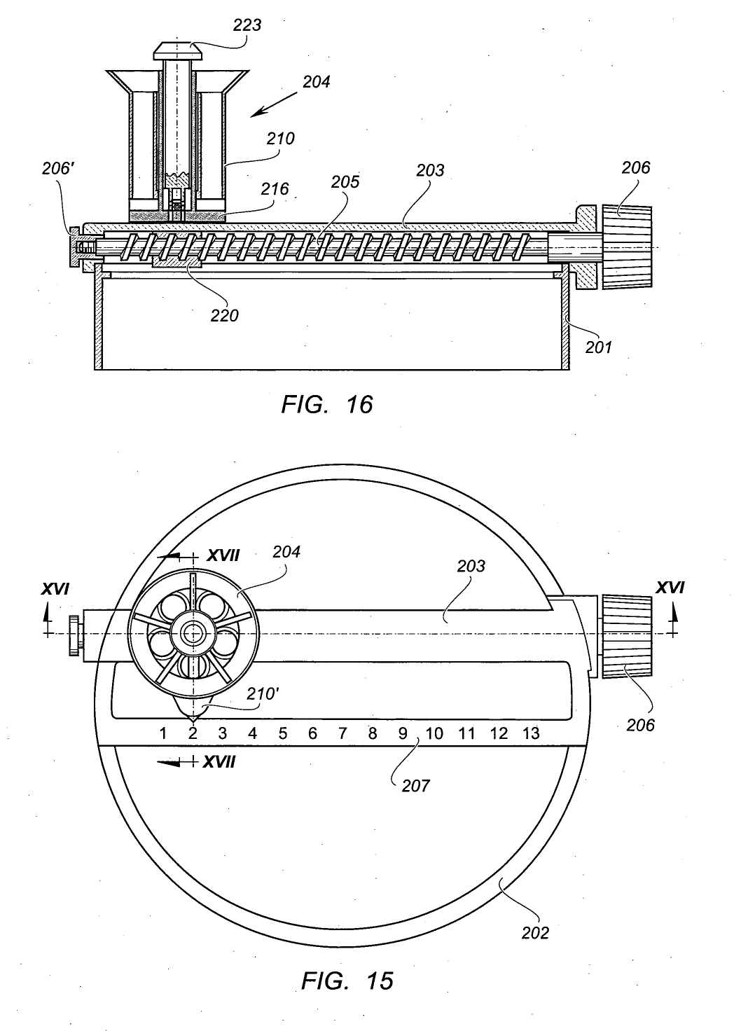

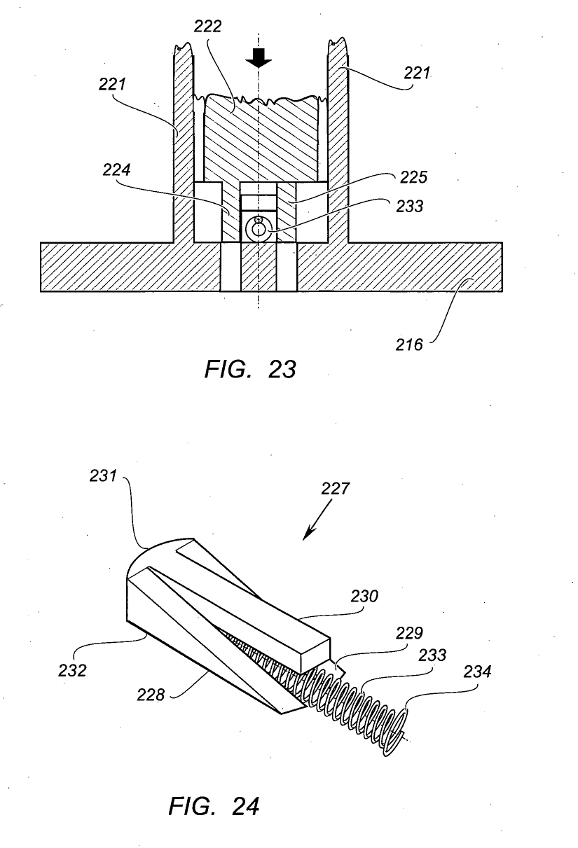

Reference shall now be made to FIGS. 14-24 pertaining to another preferred embodiment of the present invention. The objects dispensing apparatus generally designated 200 (e.g. for deploying candies on a cake) is characterized by a circular structure. Thus provided is a circular base 201 within which the cake or other substrate for the dispensed objects is to be placed (not shown).

Freely riding on the base 201 is dispenser carrier 202. The dispenser carrier 202 is thus rotatable over the base 201.

The dispenser carrier 202 comprises a cross-support beam 203 onto which is mounted a slidably supported dispenser 204. While any known type of dispenser can be used, there is proposed, according to another aspect of the invention a multi-type of objects dispenser details of which will be given further bellow. Generally, the dispenser 204 comprises a housing 210 devided into a number of compartments (five in the described example) for different kinds of candies as more clearly seen in FIG. 18.

The dispenser 204 is rotatably mounted for allowing different kind of candies (or other objects) to be ejected at the will of the user.

The dispenser 204 is displacable along the support beam 203 by being coupled to screw-thread spindle 205 oparable by knob 206 at one side and is journaled by plug 206′ at its other side. The linear progress of the dispenser can be measured by the scaled ruler 207 (numbered 1, 2, 3 . . . ) using pointer 210′.

The rotational progress of the carrier 202 over the base 201 can be measured by the scaled strip 208 (letters A, B, C . . . ) identifiable through a window 209.

It will be thus readily understood that by manipulating both the linear and the rotational positions of the dispenser 204, the later can reach over every desired point of the polar coordinates underside thereof, as in the previous, orthogonal coordinates embodiment.

As already mentioned, the dispenser 204 is of a design especially tailored for the purposes of the present invention, namely deploying candies over a cake, while the candies may be of different kinds (color, taste, etc.).

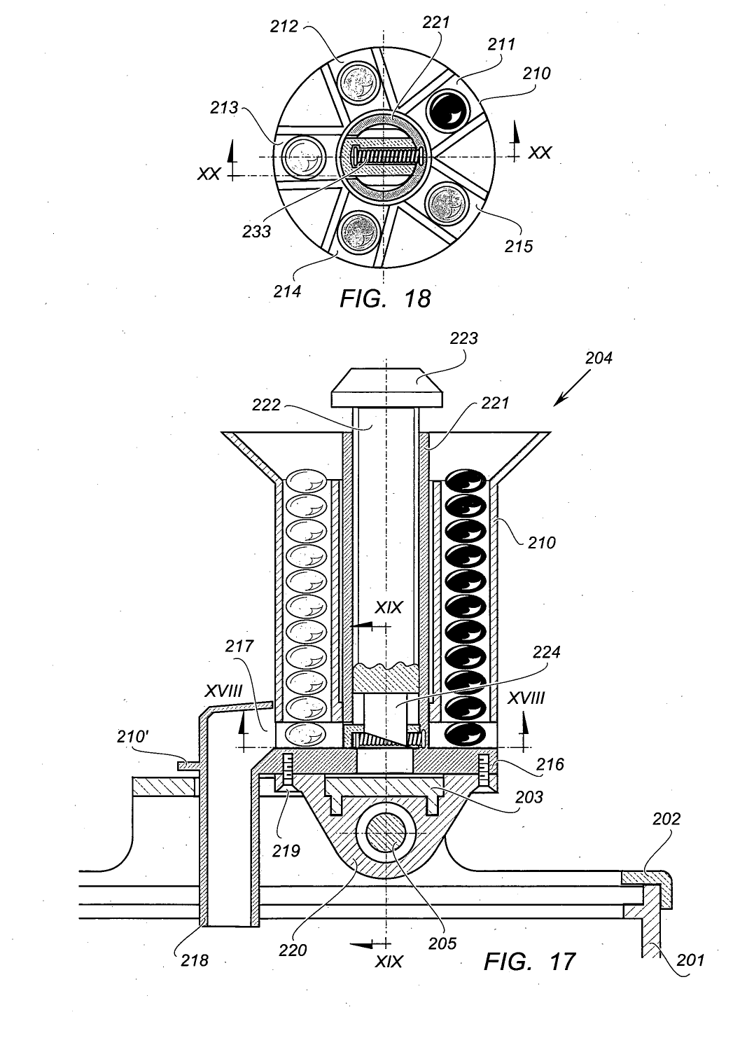

Hence, the dispenser housing 210 is cylindrical, sub-devided into five compartments 211,212,213,214 and 215, each stacked with a different kind of candies (see FIG. 17).

The housing 210 is rotatably mounted on a base plate 216 which is also formed with dispensing opening 217 leading to tubular section 218.

The base plate 216 is mounted e.g. by bolts 219 on a block 220 serving both functions of guiding over the support beam 203 and as the female (nut), screw-threaded counter-part of the spindle 205 responsible for the linear movement of the dispenser 204.

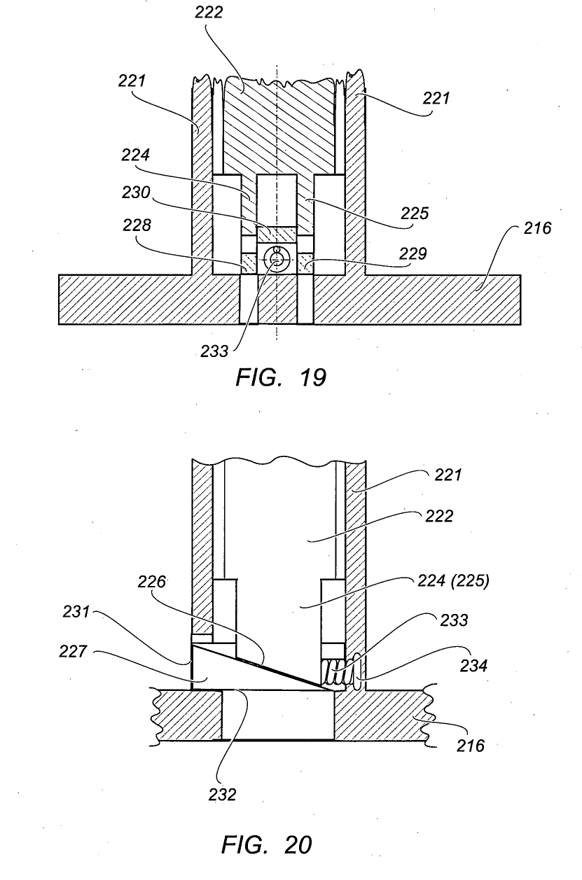

The dispenser housing 210 is rotatable with respect to the base plate 216 around sleeve 221 mounted to or forming part of the base plate 216 (see FIGS. 19 and 20).

The inner side of the sleeve 221 accommodates a reciprocable pusher 222 with head 223 at its upper end, and a pair parallel legs 224 and 225 tapered at their bottom ends (see line 226 in FIG. 20).

The legs 224 and 225 normally rest on slider member 227 best seen in FIG. 24, namely comprising a pair of wedged surfaces 228 and 229, a horizontally extending consol 230, a front pushing surface 231 and flat bottom surface 232.

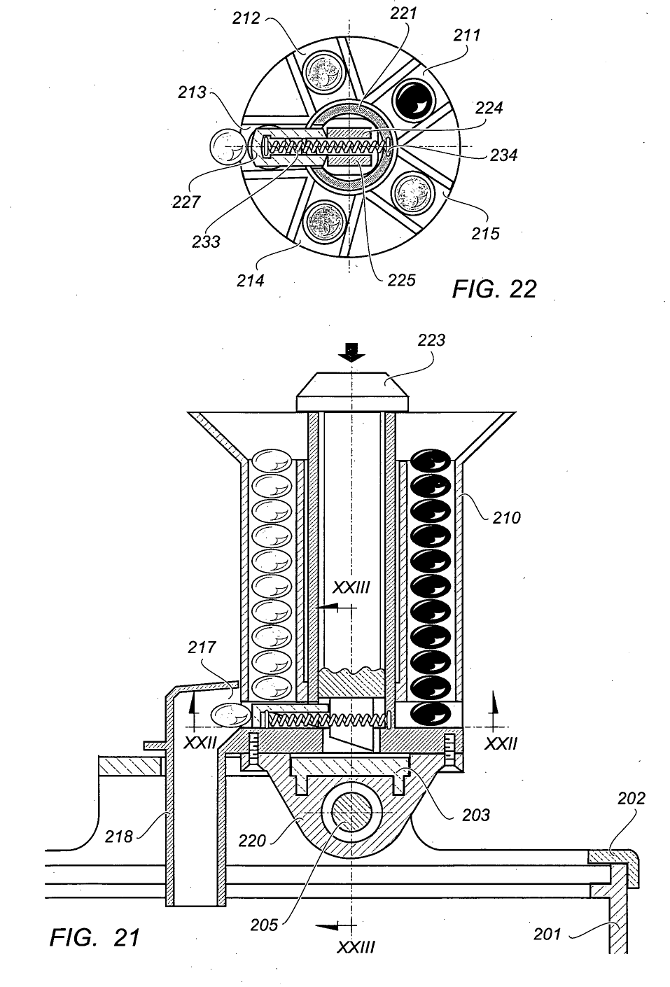

The slider 227 is connected by tension coil spring 223 (underside the consol 230) to a bottom portion (234) of the sleeve 221, maintaining its contact with the legs 224,225 along the wedge surface 226 during the extracted as well as its withdrawn stages (FIG. 21 and FIG. 17, respectively).

The slider 227 is thus adapted to be wedged away into an extended position by forcing the pusher 222 downwards as seen in FIG. 21, against the urge of the spring 223. On its way, the front surface 231 of the wedge piece 227 will sweep the first-in-line of the candies piled in front of the opening 217 and cause it to become dispensed through the dispensing sleeve 218.

The next-in-line candy is maintained in its elevated position, resting on the consol 230, until the force on the pusher 222 is relieved and the wedge-piece 227 retracts to its initial, standby position under the tension of the spring 223. It is now at the option of the user to dispense another candy of the same group, or to turret the housing 210 to a new position whereby candies of different groups will become aligned with the dispensing opening 217 after turning the rider 202 to a new angular position.

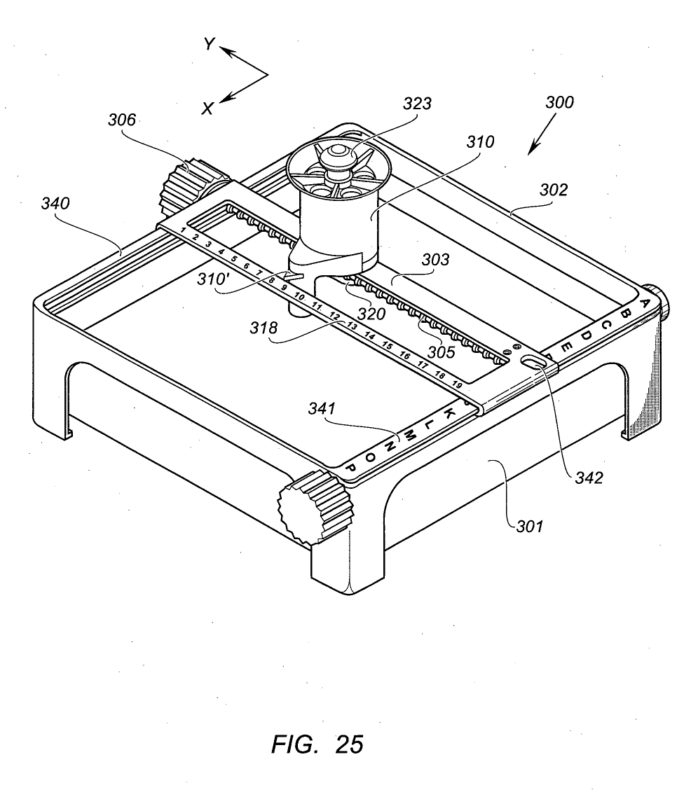

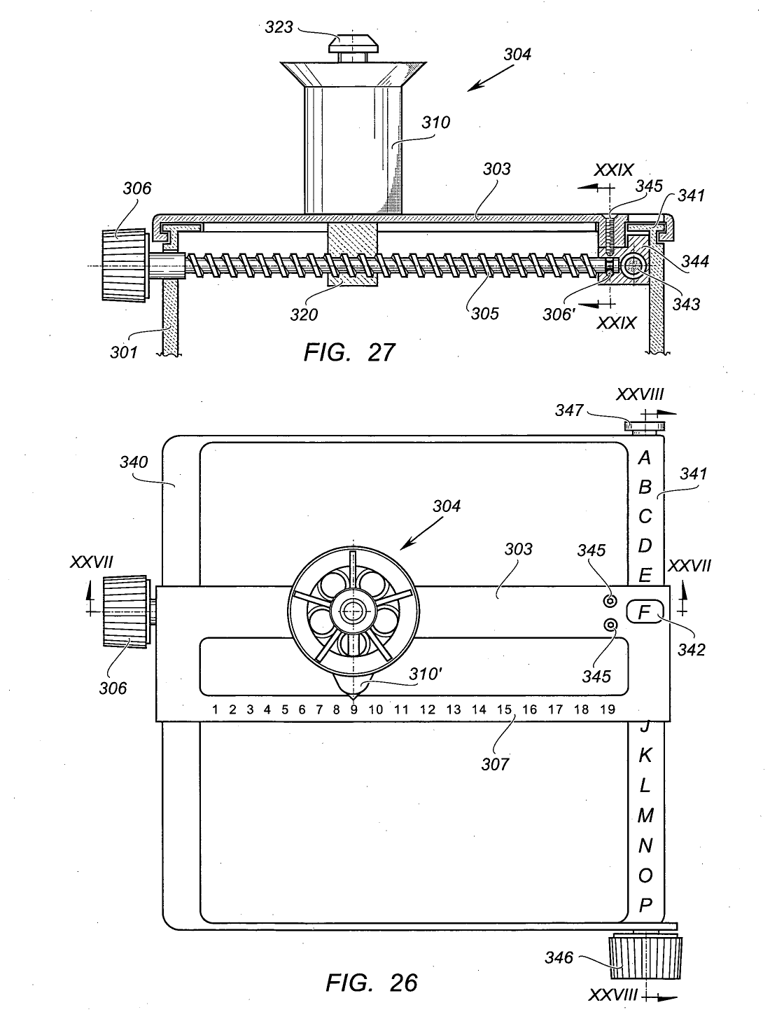

In FIGS. 25-28 yet an additional embodiment of the invention is depicted, based on orthogonal (X-Y) coordinates as in the first embodiment.

The apparatus generally denoted 300 comprises a square base 301, e.g. for the baking mold of a cake to be decorated (not shown).

Dispenser carrier 302 is also square, supported on four legs over the base 301. Otherwise, the construction of carrier is quite similar to that of the former, circular configuration of the previous embodiment; therefore, similar reference numerals will be use and certain details of construction shall not be repeated.

Hence, it will be readily seen that the dispenser 304 with push bottom 323 is coupled to spindle 305 and thus slidable from side to side (in the Y-axis direction) over support beam 303 by rotating the knob 306.

However, the dispenser carrier system as a whole is moveable (in the X-axis direction) over and along opposite side frames 340, 341, the later being marked by letters A, B, C, . . . for measuring the amount of displacement, while can be viewed through window 342.

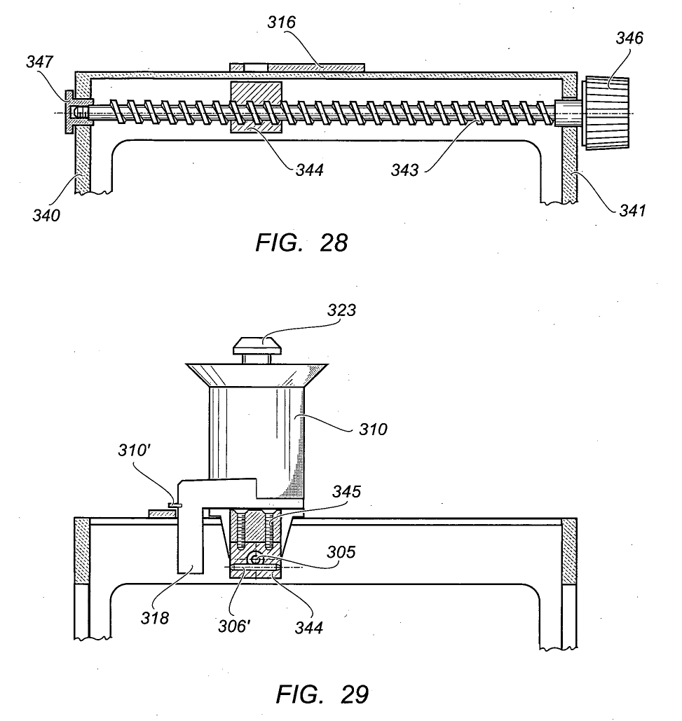

To this end, and as best seen in FIG. 28, there is provided a second spindle 343, threadably coupled to nut block 344. The block 344 is thus slidable along an inner corner of the side frame 341.

The block 344 rotatably supports the free end of the spindle 305 with restraining pin 306′.

The block 344 is rigidly connected to the dispenser carrying beam 303, as by bolts 345 so that movement imparted thereto by rotating the spindle 343, using knob 346 will bring about the movement of cross beam 303 and to dispenser 304 mounted thereon. The spindle 343 is journalled by plug 347 to side frame 340 as seen in FIG. 28.

It will be thus readily understood that by manipulating one, the other or both knobs 306 and 346 the dispenser 304 can be displaced to overlie any pre-selected point defined by the X-Y axises.

Those skilled in the art to which this invention pertains will readily appreciate that numerous changes, variations and modifications can effectuated without departing from the scope of the invention as defined in and by the appendent claims.

What is claimed:

1. An apparatus for deploying objects from an objects dispenser on to an underlying substrate according to a selected pattern, the apparatus comprising:
a rigid frame;
at-least one beam extending across the frame;
an objects dispenser device mounted to the beam;
selectively operable first means for bi-directionally propelling the objects dispensing device over said at-least one beam;
selectively operable second means for propelling the said at-least one beam over the said frame,
whereby operating one, the other or both of said first and second means the dispensing device is movable to overlie any pre-selected point over said substrate.

2. The apparatus of claim 1 wherein the said first means comprise a first screw-thread spindle coupled to a base portion supporting the dispensing device.

3. The apparatus of claim 2 wherein the screw-thread spindle is rotatable manually.

4. The apparatus of claim 3 wherein the said second means comprise means for rotating the said at-least one beam in the plane defined by said frame.

5. The apparatus of claim 4 wherein the said frame is circular, the said at-least one beam being mounted on a circular support freely riding on the frame to be manually rotatable thereon.

6. The apparatus of claim 3 wherein the said frame is square, the said at-least one beam being moveably supported by two opposite frame-members.

7. The apparatus of claim 6 wherein the said second means comprise a second screw-thread spindle coupled to one side of the said at-least one beam so that rotation of the second spindle causes the displacement of the said at-least one beam in a direction perpendicular to the direction of the opposite frame members.

8. The apparatus of claim 7 wherein the second spindle is theadable through a nut block slidable along one of said opposite frame members and rotatably supporting one end of said first spindle.

9. The apparatus of claim 1 wherein the said frame comprises four frame members the said at-least one beam consist of a carriage supported by the frame members, the carriage comprising first and second elongated carriage members extending in crossing directions;
means for movably supporting the first carriage member on a first pair of opposite frame members;
means for movably supporting the second carriage member on a second pair of opposite frame members;
means for propelling the first carriage member on and along the first pair of frame members;
means for propelling the second carriage member on and along the second pair of frame members; and
means for supporting the objects dispensing device at the crossing of the first and second carriage members.

10. The apparatus of claim 9 wherein the first and the second carriage members are each comprised of at least two beams extending parallel to each other.

11. The apparatus of claim 10 wherein the intersection of the first carriage member and the second carriage member forms a sliding support for the objects dispenser.

12. The apparatus of claim 11 wherein the means for slidingly supporting the first carriage member and the second carriage member is a gear-type wheel coupled to a gear teeth rack carried on each of the frame members.

13. The apparatus of claim 12 wherein the gear-type wheel comprises an outer section, an inner section, and a circumferential ball bearing slot therebetween.

14. The apparatus of claim 9 wherein the means for propelling the first and/or the second carriage member is a handle.

15. The apparatus of claim 9 wherein the means for propelling the first and/or the second carriage member is a servo drive.

16. The apparatus of claim 15 wherein the servo motor is remotely controlled.
